(19) United States
(12) Patent Application Publication
(10) Pub. No.: US 2007/0228193 A1
(43) Pub. Date: Oct. 4, 2007

(54) Fuel injector

(75) Inventors: Koji Kato, Aichi-ken (JP); Fumiyasu Sugiyama, Aichi-ken (JP); Hideaki Nishibu, Aichi-ken (JP); Hiroshi Kawazoe, Aichi-ken (JP)

Correspondence Address: DENNISON, SCHULTZ & MACDONALD, 1727 KING STREET, SUITE 105, ALEXANDRIA, VA, 22314, US

(73) Assignee: Aisan Kogyo Kabushiki Kaisha

(21) Appl. No.: 11/727,396

(22) Filed: Mar. 26, 2007

(30) Foreign Application Priority Data
Mar. 31, 2006 (JP) 2006-098784

(51) Int. Cl. F02M 47/02; F02M 63/00; F02M 51/00

(52) U.S. Cl. 239/533.2; 239/88; 239/585.5

(57) ABSTRACT

The invention provides an effective technique for improving the sealing performance and durability of a fluid control valve, particularly a fuel injector. The fuel injector 10 has a ball valve 32 and a valve seat body 41. A fuel jet opening 41c formed in the valve seat body 41 is closed when the ball valve 32 contacts a sealing surface 41b of the valve seat body 41, while being opened when the ball valve 31 separates from the sealing surface 41b of the valve seat body 41. A stainless steel base material and a Sn plated film softer than the base material form a smooth surface 42 on the sealing surface 41b of the valve seat body 41.

### BACKGROUND OF THE INVENTION

1. Field of the Invention

The present invention relates to a fluid control valve for controlling the flow rate of fluid, and more particularly to a fuel injector for controlling the injection rate of fuel.

2. Description of the Related Art

A fuel injector used for an internal combustion engine includes a valve and a valve seat having a fuel jet opening. The fuel injector is placed in a closed state in which the valve is in contact with the valve seat so that the fuel jet opening is closed, or in an open state in which the valve is not in contact with the valve seat so that the fuel jet opening is open. In such a fuel injector, the sealing performance for sealing in fuel between the valve and the valve seat is desired to be improved. Japanese non-examined laid-open patent publication No. 2003-65189 discloses a fluid control valve provided with a valve seat having a smaller Young's modulus than the valve. In this known fluid control valve, when the valve contacts the valve seat, the valve seat having a smaller Young's modulus than the valve elastically deforms. Due to such elastic deformation, wear of the valve can be reduced, and the sealing performance between the valve and the valve seat can be ensured.

However, the valve seat formed of a material having a smaller Young's modulus has a high ductility, so that high-accuracy processing of the valve seat is difficult. Further, the valve seat formed of a material having a smaller Young's modulus is softer, so that the valve seat itself may be wore by contact with the hard valve. Therefore, concerns are raised over the durability of the fluid control valve particularly in the case in which valve opening and closing operations are repeatedly performed.

### SUMMARY OF THE INVENTION

Accordingly, it is an object of the present invention to provide an effective technique for improving the sealing performance and durability of a fluid control valve for controlling the flow rate of fluid.

In one aspect of the present invention, a fuel injector is provided to have a valve seat having a fuel jet opening, and a valve which contacts the valve seat. Various kinds of fuel, such as gasoline, liquefied petroleum gas (LPG) and liquefied natural gas (LNG), may be utilized. A film softer than a base material is formed on at least one of a valve side contact portion and a valve seat side contact portion which contact each other. The film is formed by using various methods, such as plating. Further, the base material and the film softer than the base material form a smooth surface on at least one of the valve side contact portion and the valve seat side contact portion. Specifically, the surface of the film filled in depressions of the base material and part of the base material which is exposed to the surface of the film form the smooth surface on at least one of the valve side contact portion and the valve seat side contact portion. The smooth surface is formed by various methods, such as aging and burnishing.

In this manner, fuel leakage through the depressions of the base material can be reduced, so that the sealing performance of the fuel injector can be improved. Further, the base material of the valve side contact portion contacts the base material of the valve seat side contact portion, so that the durability (wear resistance) of the fuel injector can be enhanced.

In another aspect of the present invention, preferably, the film is formed of metallic material, and a diffusion layer is formed between the base material and the film by metal bonding of the base material and the film. The diffusion layer includes a thermal diffusion layer or other diffusion layers. The diffusion layer is formed by various methods, such as thermal diffusion.

In another aspect of the present invention, a fluid control valve is provided to have a valve seat having a fluid outlet opening, and a valve which contacts the valve seat. Various kinds of fluid in the form of liquid or gas may be utilized. Other objects, features and advantages of the present invention will be readily understood after reading the following detailed description together with the accompanying drawings and the claims.

### BRIEF DESCRIPTION OF THE DRAWINGS

FIG. 1 is a sectional view showing a fuel injector according to an embodiment of the invention.

FIG. 2 is an enlarged view of part X in FIG. 1.

FIG. 3 is an enlarged view of part Y in FIG. 2.

FIG. 4 is a schematic view illustrating a first method of forming a smooth surface.

FIG. 5 is a schematic view illustrating a second method of forming the smooth surface.

FIG. 6 shows the relationship between the number of operations and the oil tightness (mm³/min) in a conventional fuel injector and the fuel injector according to the embodiment of the present invention.

FIG. 7 is a schematic view illustrating a third method of forming the smooth surface.

FIG. 8 is a graph showing the relationship between the flow rate and the number of operations of the fuel injector having the smooth surface-formed by the third method.

### DETAILED DESCRIPTION OF THE INVENTION

The present invention is applied as a fluid control valve for controlling fluid such as liquid and gas. Suitably, the present invention is applied as a fuel injector for controlling the flow rate of fuel, including liquid fuel such as gasoline, liquefied petroleum gas (LPG) and liquefied natural gas (LNG) and gaseous fuel such as hydrogen.

The fuel injector and the fluid control valve (hereinafter generically referred to as “fuel injector”) include a valve seat having a fuel jet opening (fluid outlet opening), and a valve which contacts and separates from the valve seat. The surface of a valve side contact portion or a valve seat side contact portion which contact each other typically has protrusions and depressions of the base material. The sealing performance of the fuel injector may be deteriorated due to the existence of depressions.

In a fuel injector according to a representative embodiment of the present invention, a base material and a film softer than the base material form a smooth surface on at least one of a valve side contact portion and a valve seat side contact portion which contact each other. The film is softer than the base material so that it can easily enter the depressions of the base material. Therefore, fuel leakage through the depressions of the base material can be reduced and the sealing performance of the fuel injector can be enhanced. Further, the base material of the valve side contact portion and the base material of the valve seat side contact portion contact each other when the valve contacts the valve seat. Thus, the durability (wear resistance) of the fuel injector can be enhanced. Further, the smooth surface can be easily formed by the film.

The film is formed by plating, PVD (physical vapor deposition), CVD (chemical vapor deposition), thermal spray or other similar methods. Suitably, the film is formed as a plated film by plating.

The smooth surface is suitably formed by aging or burnishing.

Further, preferably, the film is formed of metallic material, and a diffusion layer is formed between the base material and the film by metal bonding of the base material and the film. The diffusion layer is formed by diffusion under predetermined conditions of the diffusion. Conditions defined by at least one of the time, temperature, atmosphere, etc. which are required for diffusion can be used as the diffusion conditions. Adhesion between the base material and the film can be enhanced by the diffusion layer. As a result, the durability of the fuel injector can be further enhanced.

Various materials can be used as the materials of the base material and the film, provided that the film is softer than the base material. For example, the base material can be formed of stainless steel (hardness HV: 750), and the film can be formed of at least one of Sn (hardness HV: 10 to 50), Ni (hardness HV: 200 to 300), Au (hardness Hv: 50 to 150), Cu (hardness HV: 50 to 200), Ag (hardness HV: 50 to 150) and Zn (hardness HV: 50 to 100).

Each of the additional features and method steps disclosed above and below may be utilized separately or in conjunction with other features and method steps to provide improved fuel injectors. Representative examples of the present invention, which examples utilized many of these additional features and method steps in conjunction, will now be described in detail with reference to the drawings. This detailed description is merely intended to teach a person skilled in the art further details for practicing preferred aspects of the present teachings and is not intended to limit the scope of the invention. Only the claims define the scope of the claimed invention. Therefore, combinations of features and steps disclosed within the following detailed description may not be necessary to practice the invention in the broadest sense, and are instead taught merely to particularly describe some representative examples of the invention.

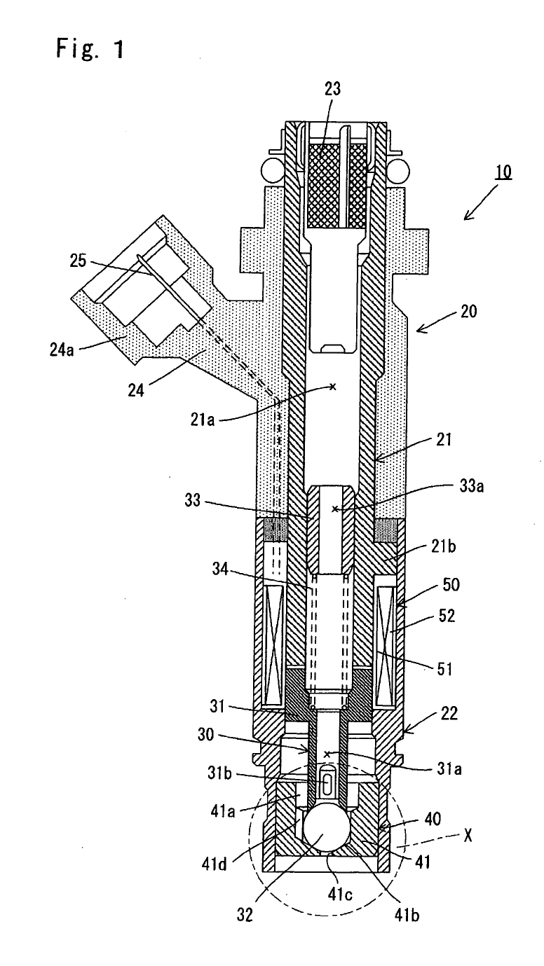

A representative embodiment of the present invention will now be described with reference to the drawings. FIG. 1 is a sectional view showing a fuel injector 10 according to an embodiment of the present invention. The fuel injector 10 controls the flow rate of fuel to be injected through a fuel jet opening. The fuel injector 10 is also referred to as a “fluid control valve” which controls the flow rate of fluid (corresponding to fuel) ejected through a fluid ejection hole (corresponding to the fuel jet opening).

The fuel injector 10 shown in FIG. 1 injects gasoline (hereinafter referred to as “fuel”) in the form of liquid supplied from a fuel tank (not shown) into a cylinder of an internal combustion engine. The fuel injector 10 includes an injector body 20, a valve 30, a valve seat 40 and a driving section 50.

The injector body 20 has a generally cylindrical shape. The inner space of the injector body 20 serves as a fuel passage 21a. Fuel flows through the fuel passage 21a from top to bottom in FIG. 1.

The injector body 20 has a fixed core 21 on the upstream side, a body 22 on the downstream side with respect to the direction of fuel flow, and a connector 24. The fixed core 21 and the body 22 are formed of magnetic metal. A flange 21b is formed on the outer peripheral surface of the fixed core 21 in a predetermined position and protrudes radially outward.

Further, a fuel filter 23 is disposed in the upstream portion of the fuel passage 21b and serves to filter fuel to be supplied to the fuel passage 21a.

The valve 30 includes a movable core 31 and a ball valve 32 that is disposed on the downstream side of the movable core 31. The valve 30 is opposed to the valve seat 40.

The movable core 31 is formed of magnetic metal and has a generally cylindrical shape. The inner space of the movable core 31 serves as a fuel passage 31a. Further, a communication hole 31b is formed through the side wall of the movable core 31 and provides communication between the fuel passage 31a and a fuel passage 41a of a valve seat body 41 which will be described below. The ball valve 32 has a spherical shape.

The valve 30 is disposed such that it can move in the axial direction of the fuel injector 10 (vertically as viewed in FIG. 1) with respect to the injector body 20 and the valve seat 40. In this embodiment, the movable core 31 of the valve 30 is disposed such that it can slide along the inner peripheral surface of the body 22.

The valve seat 40 has a valve seat body 41. The valve seat body 41 is mounted in the body 22, for example, by press-fitting. The valve seat body 41 has a generally cylindrical shape with a bottom. A sealing surface (contact surface) 41b and a fuel jet opening 41c are formed in the bottom of the valve seat body 41. The inner space of the valve seat body 41 serves as a fuel passage 41a. A groove 41d is formed in a portion of the inner peripheral surface of the valve seat body 41 which faces the ball valve 32 and extends in the axial direction (vertically as viewed in FIG. 1). Fuel can be led from the fuel passage 41a to the fuel jet opening 41c via the groove 41d.

When the ball valve 32 contacts the sealing surface 41b, the fuel jet opening 41c is closed and fuel injection stops (“closed state”). When the ball valve 32 is not in contact with the sealing surface 41b, the fuel jet opening 41c is opened and fuel is injected (“open state”).

The ball valve 32 of the valve 30 and the sealing surface 41b of the valve seat body 41 are features that correspond to the “valve side contact member” and the “valve seat side contact member”, respectively, according to this invention. Further, a portion of the ball valve 32 which contacts the sealing surface 41b, and the sealing surface 41b are features that correspond to the “valve side contact portion” and the “valve seat side contact portion”, respectively, according to this invention.

Further, a spring 34 is disposed between a spring adjuster 33 and the valve 30 (the movable core 31) and normally urges the valve 30 in the direction of contact with the sealing surface 41b of the valve seat 40 (in the direction that closes the fuel jet opening 41c).

The spring adjuster 33 is press-fitted and fixed in the fixed core 21. The biasing force of the spring 34 that urges the valve 30 toward the sealing surface 41b of the valve seat 40 can be adjusted by adjusting the position of the spring adjuster 33 to be fixed with respect to the fixed core 21.

The inner space of the spring adjuster 33 serves as a fuel passage 33a. Thus, fuel can be led to the fuel jet opening 41c via the fuel filter 23, the fuel passages 21a, 33a, 31a, 41a and the groove 41d.

A slight clearance is formed between the fixed core 21 and the movable core 31 when the ball valve 32 of the valve 30 is in contact with the sealing surface 41b of the valve seat body 41.

The driving section 50 generates a driving force for driving the valve 30. The driving section 50 includes the fixed core 21, an electromagnetic coil 52 and the body 22.

The electromagnetic coil 52 generates an electromagnetic force by the passage of electric current through its coil winding. The coil winding forming the electromagnetic coil 52 is wound on a bobbin 51 which is disposed around the fixed core 21. The bobbin 51 on which the coil winding of the electromagnetic coil 52 is wound is typically covered with resin. At this time, an end portion of a connecting wire 25 of which end is connected to the electromagnetic coil 52 is integrated by the resin.

The body 22 has a generally cylindrical shape. The body 22 is disposed over the bobbin 51 such that the outer peripheral surface of the flange 21b of the fixed core 21 contacts the inner peripheral surface of the body 22. For example, the fixed core 21 is press fitted into the body 22. At this time, the upstream end (upper end as viewed in FIG. 1) of the body 22 is located upstream of the flange 21b.

A connector 24 is formed of resin and disposed over the fixed core 21. A socket 24a is formed in the connector 24 and can receive a connecting terminal which is connected to an external power source. One end of the connecting wire 25 is connected to the electromagnetic coil 52 and the other end is placed in the socket 24a. Thus, current is supplied from the external power source to the electromagnetic coil 52 via the connecting wire 25.

The connecting wire 25 for connecting the electromagnetic coil 52 and the external power source may comprise one connecting wire or a plurality of connecting wires directly connected to each other. For example, one of the connecting wires may jut out the bobbin 51 and another may be embedded in the connector 24.

The fuel injector 10 operates as follows.

When current is supplied from the external power source to the electromagnetic coil 52 via the connecting wire 25, magnetic flux flows to the body 22 through the fixed core 21 and the movable core 31 and thus generates a driving force of moving the valve 30 (the movable core 31 and the ball valve 32) toward the fixed core 21. As a result, the valve 30 moves in a direction (upward as viewed in FIG. 1) away from the sealing surface 41b of the valve seat body 41 (the valve seat 40). The valve 30 then stops when the movable core 31 contacts the fixed core 21.

In this state, the ball valve 32 stands clear of the sealing surface 41b of the valve seat body 41. Thus, the fuel jet opening 41c is opened and fuel is injected through the fuel jet opening 41c.

When the supply of current to the electromagnetic coil 52 is stopped, the valve 30 moves in a direction (downward as viewed in FIG. 1) toward the sealing surface 41b of the valve seat body 41 (the valve seat 40) by the biasing force of the spring 34. The valve 30 then stops when the ball valve 32 contacts the sealing surface 41b of the valve seat body 41.

In this state, the fuel jet opening 41c is closed and the fuel injection from the fuel jet opening 41c is stopped (“closed state”).

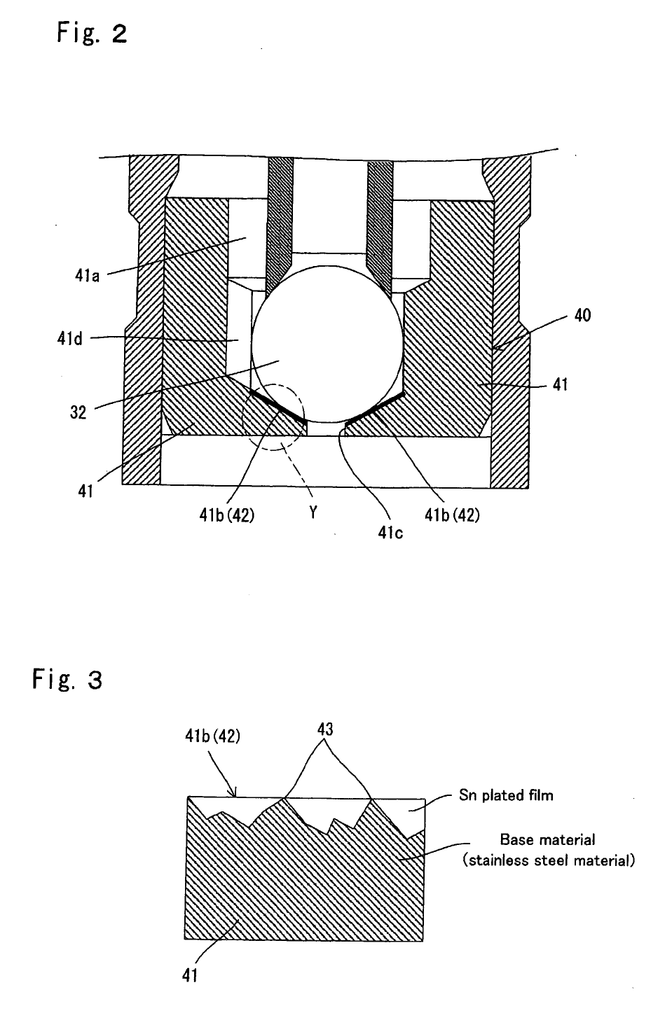

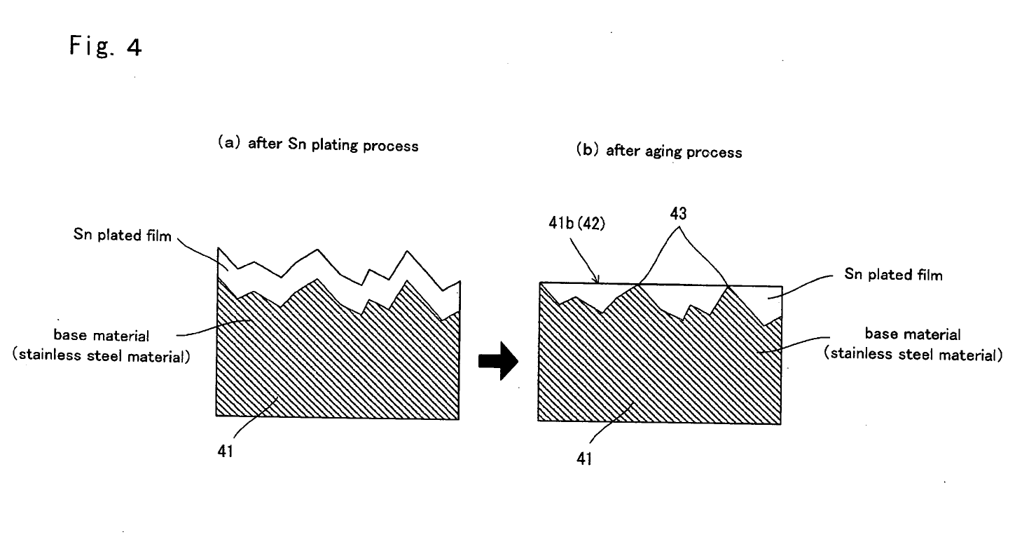

The detailed construction of the fuel injector 10 will now be described with reference to FIGS. 2 and 3. FIG. 2 is an enlarged view of part X in FIG. 1, and FIG. 3 is an enlarged view of part Y in FIG. 2.

The ball valve 32 and the valve seat body 41 are formed of stainless steel. At least a portion of the valve seat body 41 which contacts the ball valve 32 has a smooth surface (flat surface) formed by a base material and a plated film softer than the base material. In this embodiment, a smooth surface 42 is formed by a base material of stainless steel (hardness HV: 750) and a Sn plated film formed of Sn (tin) (hardness HV: 10 to 50) softer than the base material. Specifically, the smooth surface 42 is provided between the stainless steel ball valve 32 and the stainless steel valve seat body.

The smooth surface 42 will now be explained in detail.

As shown in FIG. 3, the surface of the stainless steel base material typically has projections and depressions. The depressions in the surface of the base material are filled with the Sn plated film softer than the base material. The surface of the Sn plated film filled in the depressions of the surface of the base material and part (base material exposed part) 43 of the projections which is exposed to the surface of the Sn plated film form the smooth surface 42.

The surface roughness representing the smoothness of the smooth surface 42 is lower than or equal to the maximum surface roughness of the base material which is not yet subjected to Sn plating.

The smooth surface 42, the stainless steel base material and the Sn plated film are features that correspond to the “smooth surface”, the “base material” and the “film”, respectively, according to this invention.

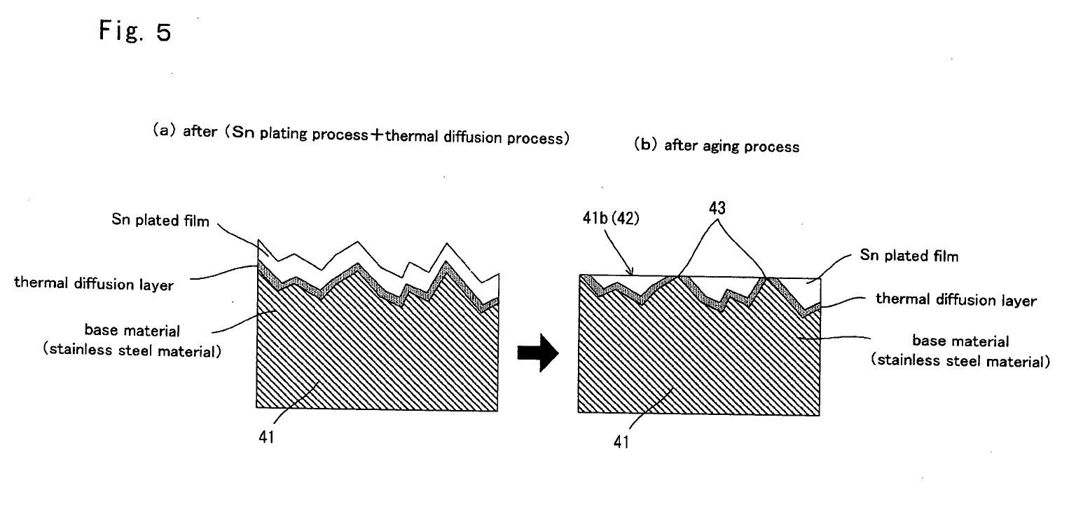

Methods of forming the smooth surface 42 will now be explained with reference to FIGS. 4 and 5. FIG. 4 shows a first method of forming the smooth surface 42, and FIG. 5 shows a second method of forming the smooth surface 42.

The first method shown in FIG. 4 includes a first step of Sn plating processing on the surface of the base material and a second step of aging process on the surface of the plated film.

In the first step (Sn plating process), the surface of the stainless steel base material is plated with Sn plating material, so that the Sn plated film is formed on the surface of the base material (see FIG. 4(a)). Known Sn plating methods can be used for plating the surface of the base material with the Sn plating material. Typically used is a method in which a direct current or pulse current is applied to an electrolyte containing Sn ions or Sn complex ions and metallic Sn is precipitated on a cathode. In this case, the Sn plated film is formed to have the thickness of, for example, about 0.5 to 1 μm. An alternative to this Sn plating method may also be used in which current is applied to a Sn plating solution to which other metal ions or other complex ions are added and Sn and the added metal are precipitated on a cathode (Sn alloy plating method).

In this Sn plating process, the surface of the base material is coated with the Sn plated film in such a manner as to cover the protrusions and fill the depressions.

In the second step (aging process), the surface of the Sn plated film formed in the first step (Sn plating process) is subjected to an aging process. Specifically, for example, the ball valve 32 is pressed against the surface of the Sn plated film several thousand times. Part of the plated film which is formed on the protrusions of the surface of the base material is removed by this aging process. As a result, a base material exposed part 43 and the surface of the Sn plated film filled in the depressions in the surface of the base material form the smooth surface 42 (see FIG. 4(b)).

The surface roughness (smoothness) of the smooth surface 42 can be improved by this aging process, so that the sealing performance of the fuel injector 10 can be effectively enhanced.

The second method shown in FIG. 5 includes a first step of Sn plating processing on the surface of the base material, a second step of diffusion and a third step of aging process on the surface of the plated film.

The first step (Sn plating process) is performed in a similar manner as in the first step (Sn plating process) of the first method.

In the second step (diffusion process), the base material coated with the Sn plated film in the first step is placed under predetermined conditions and subjected to a diffusion process. For example, the base material coated with the Sn plated film is placed under conditions of an ambient temperature of 180° C. for 60 minutes and subjected to a thermal diffusion process. This thermal diffusion causes metal bonding of the stainless steel base material and the Sn plated film, resulting in that a thermal diffusion layer having a higher adhesion (durability) is formed between the base material and the Sn plated film (see FIG. 5(a)). The thermal diffusion layer formed between the base material and the Sn plated film can prevent the Sn plated film from being easily separated from the base material. Conditions defined by at least one of the time, temperature, atmosphere, etc. which are required for diffusion can be used as the conditions for forming a diffusion layer such as a thermal diffusion layer between the base material and the Sn plated film.

The third step (aging process) is performed in a similar manner as in the second step (aging process) of the first method. By this aging process, like in the first method, the base material exposed part 43 and the surface of the Sn plated film filled in the depressions in the surface of the base material form the smooth surface 42 (see FIG. 5(b)).

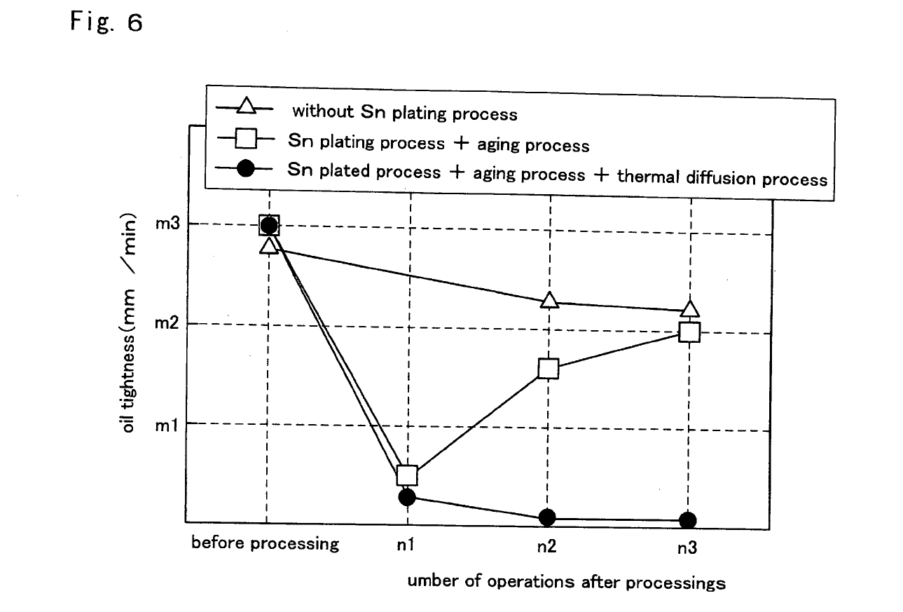

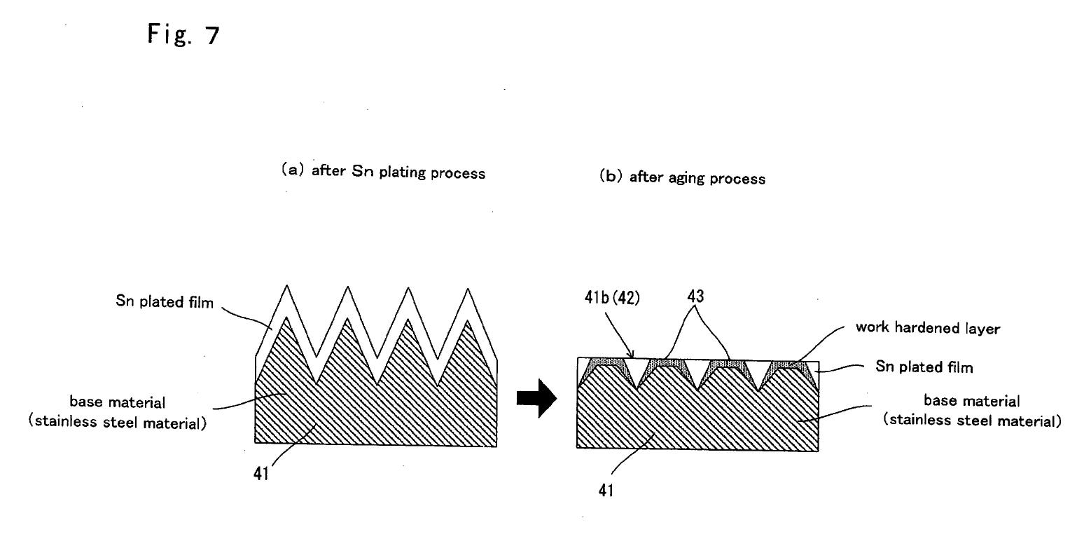

The operating durability performance of the fuel injector 10 having the smooth surface 42 formed by the first method and the fuel injector 10 having the smooth surface 42 formed by the second method will now be explained with reference to FIG. 6. FIG. 6 is a graph showing the relationship between the number of operations of the fuel injector 10 and the oil tightness (mm³/min) in the closed state. In FIG. 6, the number of operations (n1<n2<n3) is plotted along the abscissa, and the oil tightness (m1<m2<m3) is plotted along the ordinate. The smaller the value of the oil tightness, the sealing performance is higher.

In FIG. 6, a line graph with symbols Δ shows the property of the fuel injector 10 which is not subjected to Sn plating, a line graph with symbols □ shows the property of the fuel injector 10 which is subjected to Sn plating and aging (by the first method), and a line graph with symbols ● shows the property of the fuel injector 10 which is subjected to Sn plating, thermal diffusion and aging (by the second method).

As clearly seen from FIG. 6, the value of the oil tightness of the fuel injector having the smooth surface 42 formed by the first or second method is smaller than that of the fuel injector without the smooth surface 42. In other words, it can be seen that the sealing performance is improved. This is effectively attained by the fact that the surface roughness (smoothness) of the smooth surface 42 is improved by the above-mentioned Sn plating and aging. Particularly, in the case of the second method, it can be seen that the values of the oil tightness are kept low even if the number of operations reaches n3 (n3>n2>n1). In other words, it can be seen that the sealing performance is maintained at a higher level. This is effectively attained by the fact that the thermal diffusion layer having a higher adhesion is formed between the base material and the Sn plated film and can prevent the Sn plated film from being separated from the base material. Therefore, higher sealing performance can be maintained for a longer period of time, so that higher durability can be obtained.

The smooth surface 42 can also be formed by a third method shown in FIG. 7, instead of the above-described first and second methods.

The third method shown in FIG. 7 includes a first step of Sn plating processing on the surface of the base material and a second step of burnishing the surface of the Sn plated film.

The first step (Sn plating process) is performed in a similar manner as the first step (Sn plating process) of the first method (see FIG. 7(a)).

In the second step (burnishing process), the surface of the Sn plated film formed in the first step is subjected to a burnishing process. As a result, the surface of the base material coated with the Sn plated film is pressed and flattened. For example, a working tool such as a high hardness ball retained by hydraulic pressure is rolled (in compression rolling contact) on the surface of the Sn plated film under predetermined conditions (for example, at the work peripheral velocity of 100 m/min, the feed of 0.1 mm/rev and the pressure of 35 MPa). By this burnishing process, part of the Sn plating which protrudes from the surface of the base material is removed, and a work hardened layer is formed on the surface of the base material (see FIG. 7(b)). The work hardened layer is formed within the range of several μm from the surface of the base material and comprises a coating layer having high hardness and high wear resistance. When the smooth surface is thus formed by using the burnishing process, the work hardened layer is formed on the surface of the base material, so that the wear resistance of the smooth surface is improved. And the width of the depressions of the base material become narrower, so that the performance for preventing the foreign object caught is improved.

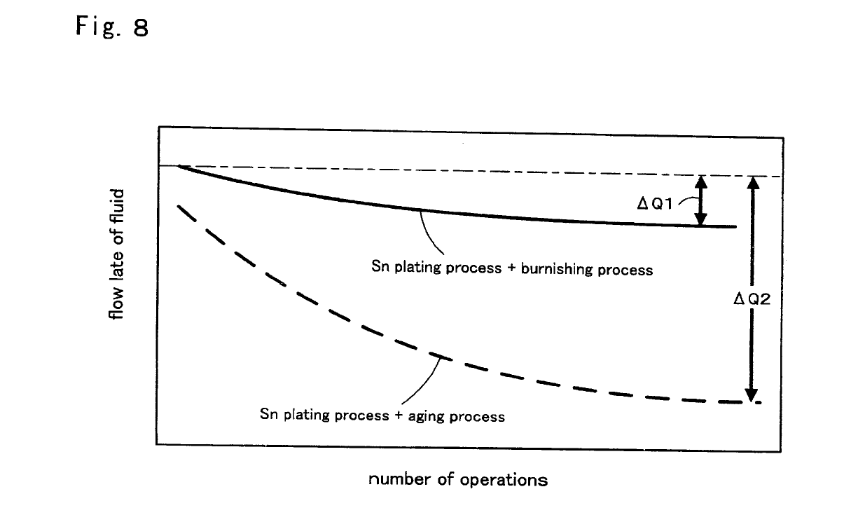

Further, when the third method is used to form the smooth surface, the change of the flow rate of the fuel injector becomes smaller due to improvement in the wear resistance of the smooth surface. The smaller change of the flow rate of the fuel injector is shown in FIG. 8. FIG. 8 is a graph showing the relationship between the flow rate and the number of operations of the fuel injector having the smooth surface formed by the third method (burnishing process). As shown in FIG. 8, by using the third method (burnishing process), compared with the case using the aging process like in the first and second methods, the change of the flow rate of the fuel injector can be made smaller.

When the burnishing process is performed, advantageously, the aging process of pressing the valve against the valve seat several thousand times is not required.

A thermal diffusion process may be performed like in the second method before the burnishing process as necessary. For example, the base material coated with the Sn plated film is placed under conditions of an ambient temperature of 180° C. for 60 minutes, so that a thermal diffusion layer is formed between the base material and the Sn plated film.

As mentioned above, in this embodiment, the Sn plated film softer than the stainless steel base material is formed on the sealing surface 41b (the valve seat 40) which contacts the ball valve 32 (the valve 30). The depressions in the surface of the base material are filled with the Sn plated film. Thus, in the closed state of the fuel injector 10, fuel is prevented from leaking through the depressions in the surface of the base material. Therefore, the sealing performance of the fuel injector 10 can be enhanced.

Further, the smooth surface 42 is formed on the sealing surface 41b by the surface of the Sn plated film filled in the depressions of the surface of the base material and the base material exposed part 43 exposed to the surface of the Sn plated film. Therefore, in the closed state of the fuel injector 10, the ball valve 32 contacts the base material exposed part 43 of the sealing surface 41b. In other words, hard stainless steel base materials contact each other. Thus, the valve durability (wear resistance) of the fuel injector 10 can be enhanced. Further, the method of forming a film on the base material can realize processing with higher accuracy compared with the method of mounting an additional member on the base material.

Further, the thermal diffusion layer is formed between the base material and the Sn plated film by metal bonding. Thus, adhesion between the stainless steel base material and the Sn plated film can be enhanced, so that the Sn plated film can be prevented from being separated from the base material. This construction is particularly effective in the case in which the number of operations (strokes) of the valve is relatively large.

The present invention is not limited to the constructions that have been described as the representative embodiments, but rather, may be added to, changed, replaced with alternatives or otherwise modified without departing from the spirit and scope of the invention.

Although, in this embodiment, the Sn plated film is formed on the sealing surface 41b which contacts the ball valve 32, the same effect can be obtained by forming the Sn plated film on at least one of a valve side contact portion (the ball valve 32) and a valve seat side contact portion (the sealing surface 41b).

Further, in this embodiment, the Sn plated film (hardness HV: 10 to 50) is formed on the stainless steel base material (hardness HV: 750), but it is only essential for the plated film to be softer than the base material. For example, other plated films, such as Ni plated film (hardness HV: 200 to 300), Au plated film (hardness HV: 50 to 150), Cu plated film (hardness HV: 50 to 200), Ag plated film (hardness HV: 50 to 150) and Zn plated film (hardness HV: 50 to 100), may be formed on the stainless steel base material. Further, two or more of these plated films may be used in combination. For example, two of Zn plated film, Au plated film and Cu plated film may be used in combination, or all of the three may be used in combination. When the resistance to corrosion by fuel and the material costs are considered, it is preferable to select Sn which is highly resistant to corrosion by fuel and low in cost, as the plating material.

Further, a base material of brass (hardness HV: 200 to 300) may be used as the base material. Further, metal film and resin film which are softer than the base material may be formed on the base material. Further, steel, such as heat-resistant steel and bearing steel, and titanium alloy may also be used as the base material.

In this embodiment, plating is used as a method of forming a softer film than the base material on the surface of the base material, but other methods may be used. For example, a PVD (physical vapor deposition) method, a CVD (chemical vapor deposition) method and a thermal spray method may be used. Further, the film is not limited to a plated film.

In this embodiment, the thermal diffusion layer is formed between the base material and the film by using the thermal diffusion method, but other various diffusion layers may be formed by using appropriate diffusion methods.

In this embodiment, the flow rate of gasoline to be injected to the internal combustion engine is controlled, but the technique of the present invention can also be used to control the flow rate of various kinds of fuel in the form of liquid or gas. For example, it can be used to control liquefied petroleum gas (LPG), liquefied natural gas (LNG), hydrogen or other fuel. Further, it can also be used to control the flow rate of various kinds of fluid including fuel.

The present invention is formed as a fuel injector for controlling the flow rate of fuel in this embodiment, but it may also be formed as a regulator, a relief valve, a cutoff valve, a check valve, etc. It is to be noted here that a fluid control valve having the smooth surface 42 formed by the above-mentioned second method (Sn plating+thermal diffusion+aging) has a higher durability than a fluid control valve having the smooth surface 42 formed by the above-mentioned first method (Sn plating+aging). Therefore, as for fluid control valves, such as an injector and a regulator, in which the number of operations (strokes) of the valve is relatively large, it is preferable to use the second method to form the smooth surface. On the other hand, as for fluid control valves, such as a cutoff valve and a check valve, in which the number of operations (strokes) of the valve is relatively small, the first method can also be used to form the smooth surface. Further, when the number of operations of the valve is large, a third method (Sn plating+burnishing) may also be used to form the smooth surface.

Further, the above-mentioned constructions may be used separately or in combination of two or more of them.

What we claim is:

1. A fuel injector, including a valve and a valve seat having a fuel jet opening, the fuel injector being placed in a closed state in which the valve is in contact with the valve seat so that the fuel jet opening is closed, or in an open state in which the valve is not in contact with the valve seat so that the fuel jet opening is open, wherein:
a smooth surface is formed of a base material and a film softer than the base material on at least one of a contact portion on the valve side and a contact portion on the valve seat side.

2. The fuel injector as defined in claim 1, wherein the film is formed of metallic material softer than the base material, and a diffusion layer is formed between the base material and the film by metal bonding of the base material and the film.

3. The fuel injector as defined in claim 2, wherein the diffusion layer comprises a thermal diffusion layer formed by thermal diffusion.

4. The fuel injector as defined in claim 2, wherein the base material is formed of stainless steel and Sn is used as the metallic material.

5. The fuel injector as defined in claim 1, wherein the film is formed by plating the base material with metallic material softer than the base material.

6. The fuel injector as defined in claim 5, wherein a diffusion layer is formed between the base material and the film by metal bonding of the base material and the film.

7. The fuel injector as defined in claim 6, wherein the diffusion layer comprises a thermal diffusion layer formed by thermal diffusion.

8. The fuel injector as defined in claim 5, wherein the base material is formed of stainless steel and Sn is used as the metallic material.

9. A fluid control valve, including a valve and a valve seat having a fluid outlet opening, the fluid control valve being placed in a closed state in which the valve is in contact with the valve seat so that the fluid outlet opening is closed, or in an open state in which the valve is not in contact with the valve seat so that the fluid outlet opening is open, wherein:
a smooth surface is formed of a base material and a film softer than the base material on at least one of a contact portion on the valve side and a contact portion on the valve seat side.

10. The fluid control valve as defined in claim 9, wherein the film is formed of metallic material softer than the base material.

11. The fluid control valve as defined in claim 10, wherein a diffusion layer is formed between the base material and the film by metal bonding of the base material and the film.

12. The fluid control valve as defined in claim 11 wherein the diffusion layer comprises a thermal diffusion layer formed by thermal diffusion.

13. The fluid control valve as defined in claim 10, wherein the base material is formed of stainless steel and Sn is used as the metallic material.

14. The fluid control valve as defined in claim 10, wherein the film is formed by plating the base material with metallic material softer than the base material.

15. The fluid control valve as defined in claim 14, wherein a diffusion layer is formed between the base material and the film by metal bonding of the base material and the film.

16. The fluid control valve as defined in claim 15, wherein the diffusion layer comprises a thermal diffusion layer formed by thermal diffusion.

17. A method for manufacturing a fuel injector including a valve and a valve seat having a fuel jet opening, the fuel injector being placed in a closed state in which the valve is in contact with the valve seat so that the fuel jet opening is closed, or in an open state in which the valve is not in contact with the valve seat so that the fuel jet opening is open, the method comprising steps of:
forming a film softer than a base material on at least one of a contact portion on the valve seat side and a contact portion on the valve side, and
aging the surface of the film to thereby form a smooth surface by the base material and the film.

18. The method as defined in claim 17, further comprising a step of performing a diffusion process before the aging step to thereby form a diffusion layer between the base material and the film.

19. A method for manufacturing a fuel injector including a valve and a valve seat having a fuel jet opening, the fuel injector being placed in a closed state in which the valve is in contact with the valve seat so that the fuel jet opening is closed, or in an open state in which the valve is not in contact with the valve seat so that the fuel jet opening is open, the method comprising the steps of:
forming a film softer than a base material on at least one of a contact portion on the valve seat side and a contact portion on the valve side, and
burnishing the surface of the film to thereby form a smooth surface by the base material and the film.
